(19) United States
(12) Patent Application Publication
(10) Pub. No.: US 2009/0296640 A1
(43) Pub. Date: Dec. 3, 2009

(54) METHOD FOR OPTIMIZING THE USE OF SHARED COMMUNICATION CHANNELS AND DEDICATED COMMUNICATION CHANNELS IN A COMMUNICATION SYSTEM

(75) Inventor: Stephen S. Gilbert, Lake Zurich, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/130,501

(22) Filed: May 30, 2008

(51) Int. Cl. H04Q 7/00

(52) U.S. Cl. 370/329

(57) ABSTRACT

A method for optimizing the use of at least one shared communication channel and at least one dedicated communication channel in a communication system. First, communication of a first plurality of communication traffic is allocated to a dedicated communication channel. Similarly, communication of a second plurality of communication traffic is allocated to a shared communication channel. Next, a change is detected in one or more channel performance metrics of the shared communication channel. When the detected change is a degradation in the one or more channel performance metrics of the shared communication channel, communication of at least one of the second plurality of communication traffic is re-allocated to the dedicated communication channel. When the detected change is an improvement in one or more channel performance metrics of the shared communication channel, communication of at least one of the first plurality of communication traffic is re-allocated to the shared communication channel.

### FIELD OF THE DISCLOSURE

The present disclosure relates generally to communication systems and more particularly to methods and systems for using shared radio spectrum in wireless communication systems.

### BACKGROUND

Conventional commercial two-way radio communication systems typically use licensed spectrum for communication purposes, as reliable communication is important in such systems. However, the licensed spectrum is generally obtained for long periods of time and it can be very costly to acquire the right to use this spectrum through a government auction, for example.

This challenge has sometimes been mitigated by taking advantage of certain license free bands which can be used by commercial communication systems without cost. It is also allowed to lease spectrum on a temporary basis from current spectrum license holders in a secondary market, thus avoiding the cost of acquiring the spectrum at an auction. Both the unlicensed spectrum and the temporarily leased spectrum may be categorized as shared spectrum because they are shared to some degree, either concurrently or consecutively, with other systems or users. A disadvantage of using shared spectrum is that at any given time it may be unavailable due to its use by the other systems or users, preventing the initiation of a new communication session. In addition, ongoing communication over the shared spectrum may be terminated prematurely if the shared spectrum becomes unusable due to interference or the expiration of a leasing period and no other unused spectrum is available.

Accordingly, there is a need for a method for using shared spectrum in a commercial two-way radio system which addresses at least some of the shortcomings of past and present techniques of communication between wireless devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart of a method for optimizing the use of a shared communication channel and a dedicated communication channel in a communication system in accordance with some embodiments.

FIG. 2 is a block diagram illustrating allocation of communication traffic to a dedicated communication channel and a shared communication channel in a communication system in accordance with some embodiments.

FIG. 3 is a block diagram illustrating the subsequent introduction of a degradation in one or more channel performance metrics of the shared communication channel in the communication system of FIG. 2 in accordance with some embodiments.

FIG. 4 is a block diagram illustrating the re-allocation of at least some of communication traffic from the shared communication channel to the dedicated communication channel in response to the detection of a degradation in one or more channel performance metrics of the shared communication channel in the communication system of FIG. 2 and FIG. 3 in accordance with some embodiments.

FIG. 5 is a block diagram illustrating a radio controller operating within a communication system in accordance with some embodiments.

FIG. 6 is a flowchart of a method for optimizing the use of a shared communication channel and a dedicated communication channel in a radio communication system in accordance with some embodiments.

FIG. 7 is a block diagram illustrating an example wireless communication network operating in accordance with some embodiments.

FIG. 8 is a block diagram illustrating an example wireless communication network operating in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, a method for optimizing the use of at least one shared communication channel and at least one dedicated communication channel in a communication system is described hereafter. First, communication of a first plurality of communication traffic is allocated to the at least one dedicated communication channel. Similarly, communication of a second plurality of communication traffic is allocated to the at least one shared communication channel. Next, a change is detected in one or more channel performance metrics of the at least one shared communication channel. Thereafter, a re-allocation of the first plurality of communication traffic and the second plurality of communication traffic is performed based at least in part on the detected change.

The method of the present invention allows the system to gain economic and capacity benefits from using shared communication channels while still providing service reliability benefits to the communications traffic which are associated with the use of dedicated channels.

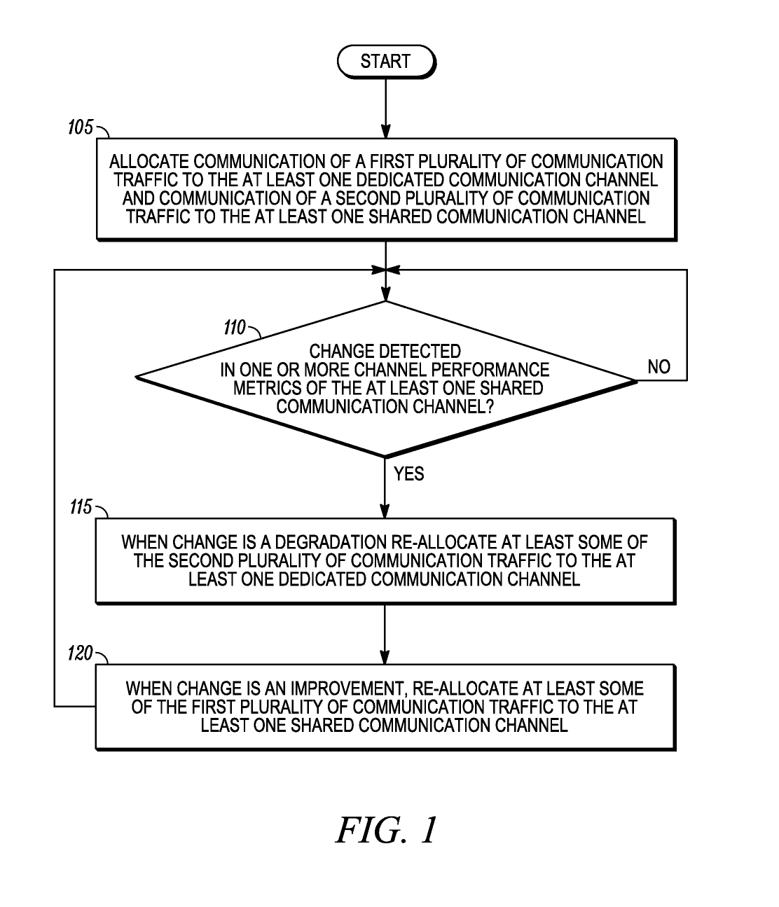

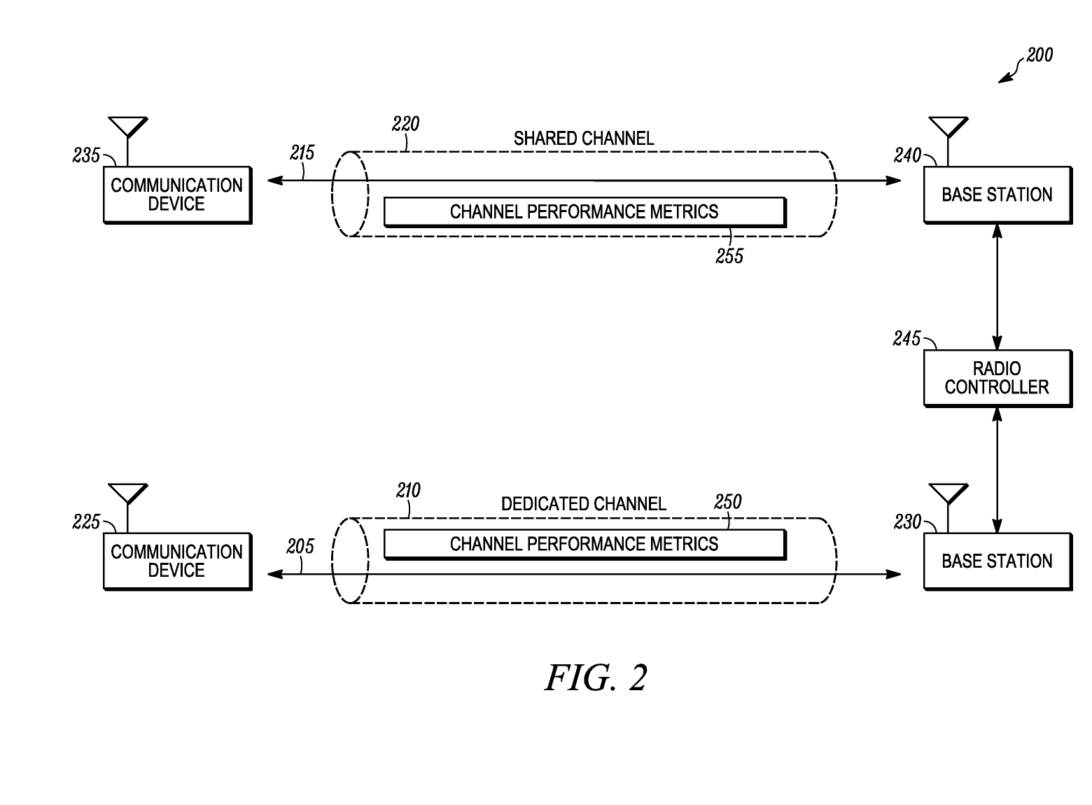

Referring now to the drawings, and in particular FIG. 1, a flowchart of a method for optimizing the use of at least one shared communication channel and at least one dedicated communication channel in a communication system in accordance with some embodiments is described hereafter. In an embodiment, the communication system is one of a radio communication system, a wired communication system, a fiber optic communication system, or any other equivalent system. At Step 105, communication of a first plurality of communication traffic is allocated to the at least one dedicated communication channel and communication of a second plurality of communication traffic is allocated to the at least one shared communication channel. This is explained in detail in conjunction with FIG. 2.

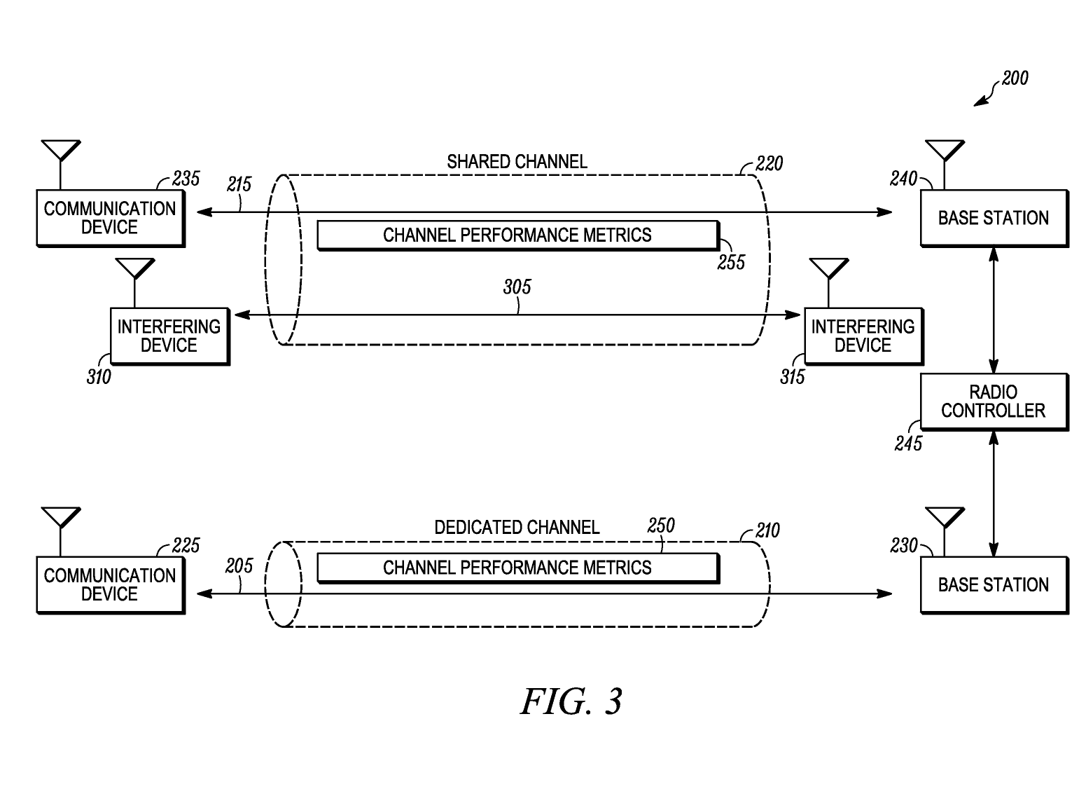

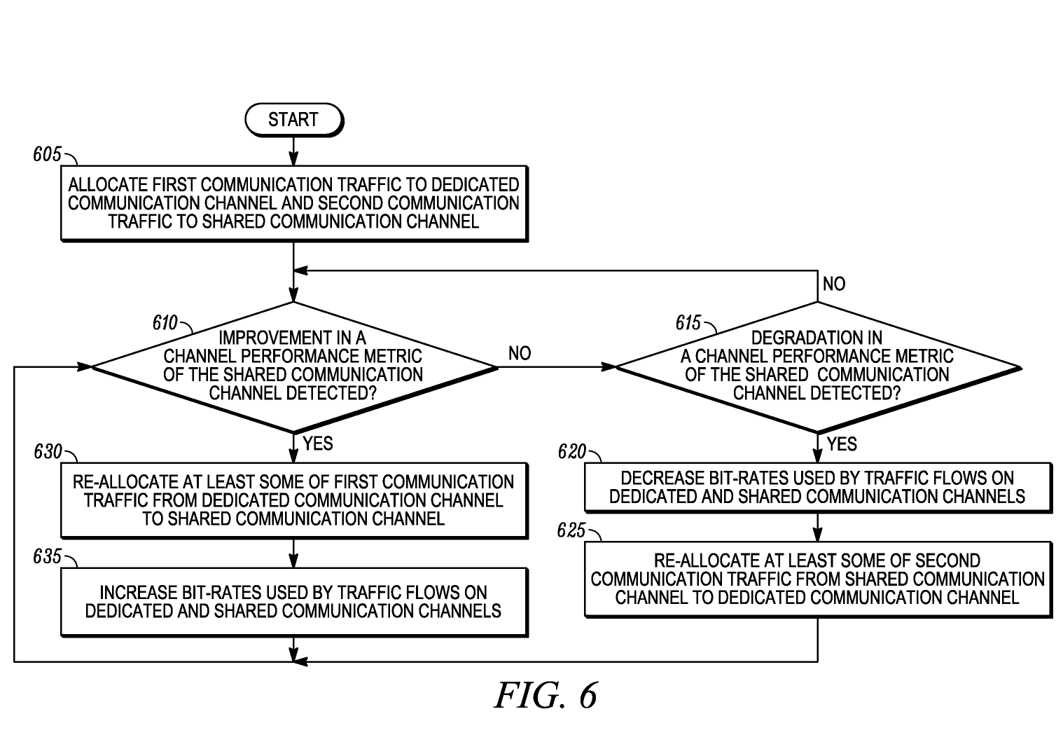

Thereafter, at Step 110, it is determined whether there is a change in one or more channel performance metrics of the at least one shared communication channel. This is explained in detail in conjunction with FIG. 3. The change in the one or more channel performance metrics may be an improvement or a degradation in the one or more channel performance metrics. This is explained in detail in conjunction with FIG. 6. The one or more channel performance metrics include, for example, an interference level, a channel capacity, a channel quality, a channel load, or any other similar channel performance metric. In an embodiment, the channel load is determined based on one or more of a number of communication users, a bandwidth requirement of the communication users, and an amount of available spectrum. When a change is not detected, the process periodically checks for such change at step 110.

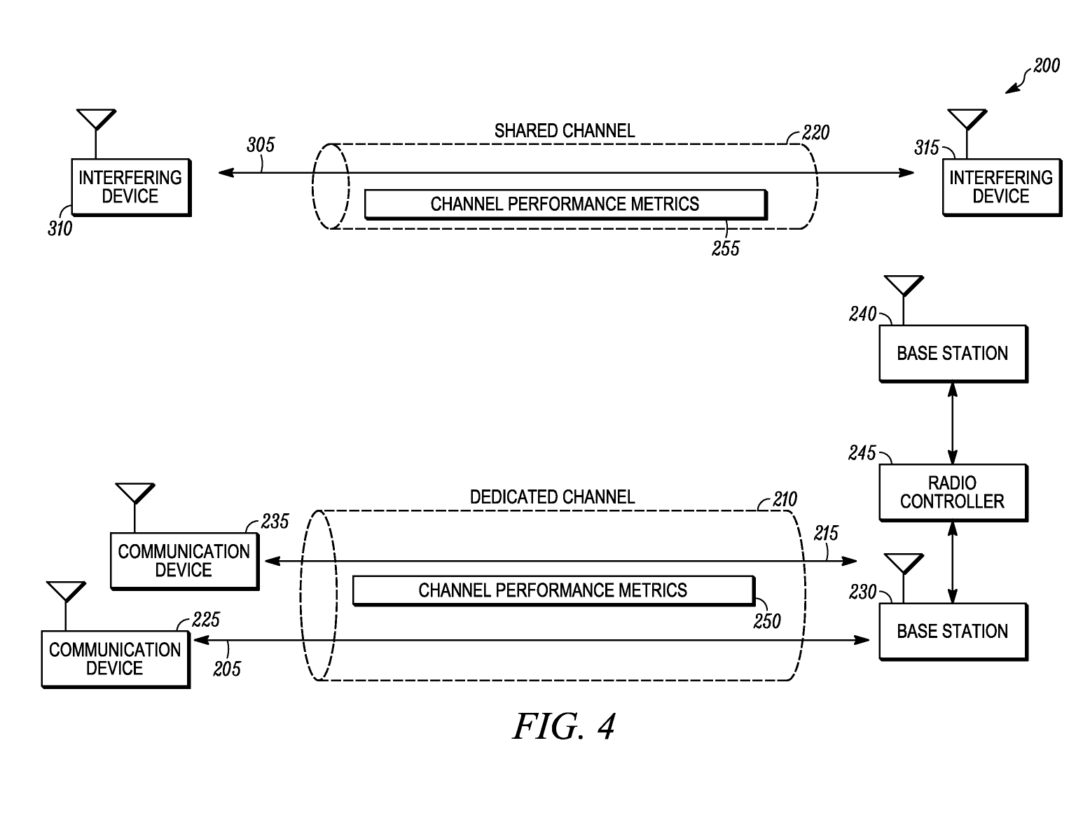

In Step 115, when the detected change is a degradation in one or more channel performance metrics of the at least one shared communication channel, at least some of the second plurality of communication traffic is re-allocated to the at least one dedicated communication channel. Alternatively, in Step 120, when the detected change is an improvement in one or more channel performance metrics of the at least one shared communication channel, at least some of the first plurality of communication traffic is re-allocated from the at least one dedicated communication channel to the at least one shared communication channel. This is further described in conjunction with FIG. 4 and FIG. 6. The process then cycles back to Step 110 and periodically checks for detection of a change.

In one embodiment (not illustrated), a change threshold is set in which the process checks for detection not just a change, but also an amount of a degradation to be above the change threshold. Thereafter, a degradation in channel quality below the change threshold would not cause a reallocation. Degradations above the change threshold would initiate the reallocating from the shared communication channel to the dedicated communication channel.

In an embodiment, a bit rate used by at least some communication of at least one of the first plurality of communication traffic and the second plurality of communication traffic is changed, in response to the detecting a change in one or more channel performance metrics of the at least one shared communication channel. The bit rate used by the at least some communication may be changed by configuring one or more of an audio encoding algorithm, a video encoding algorithm, a data compression algorithm, or a forward error correction algorithm, applied to the at least some communication of at least one of the first plurality of communication traffic and the second plurality of communication traffic.

Turning now to FIG. 2, a block diagram illustrating allocation of communication traffic to at least one dedicated communication channel and at least one shared communication channel in a communication system in accordance with some embodiments is described hereafter. Specifically, FIG. 2 illustrates the allocation of communication of a first plurality of communication traffic 205 to a dedicated communication channel 210 and the allocation of communication of a second plurality of communication traffic 215 to a shared communication channel 220 in a communication system 200 It will be appreciated by those of ordinary skill in the art, that, although one shared communication and one dedicated communication channel are illustrated in FIG. 1, any number of shared and dedicated communication channels can be implemented in accordance with the present invention.

In one embodiment, the communication system 200 is a commercial two-way mobile radio system such as a Cellular Communication System, a Personal Communication System, or a Trunked Radio System. The communication system can also be a private radio system or a public safety radio system or any combination thereof. Alternatively, the communication system can be a wired communication system or a fiber optic communication system. The shared communication channel 220, in one embodiment, includes an unlicensed spectrum or alternatively, a licensed spectrum which is temporarily available for communication of communication traffic. For example, the licensed spectrum can be spectrum whose use is granted through short term leases on a secondary market for spectrum. The shared communication channel 220, in other words, includes “unreliable” or shared spectrum which is used opportunistically when it is available or can be leased at an acceptable price. Two types of unreliable shared spectrum are unlicensed spectrum in which interference by other users is the primary limitation on use, and spectrum which is licensed by another entity but can be “leased” from that entity for a limited time period (possibly on the order of minutes) for a price which might be dynamically negotiated. This could be considered “spot market” spectrum. The licensed spectrum, for example, can be temporarily made available for communication of communication traffic as a result of a decision using at least one of an automated negotiation protocol, an automated auction mechanism, and an automated application of policy rules. It will be appreciated that the amount of spectrum available to the communication system will fluctuate due to interference or being out-bid by competing lessors. The interference can be recognized by the mobile or fixed equipment, and the availability of leased spectrum can be determined by an automated negotiation (or auction) protocol between the radio system infrastructure and a server run by an entity (such as the licensee) who grants access to the leased spectrum.

The dedicated communication channel 210, for example, can include “reliable” spectrum which is either licensed directly from the Federal Communications Commission (FCC) for a relatively long term (years) by traditional means, or is spectrum which is leased for a long term (years) on a secondary market from an entity that has rights to the spectrum.

The first plurality of communication traffic 205 includes communication between a communication device 225 and a base station 230 along the dedicated communication channel 210. The second plurality of communication traffic 215 includes communication between a communication device 235 and a base station 240 along the shared communication channel 220. The first plurality of communication traffic 205 and the second plurality of communication traffic 215 may include, for example, voice communications, data packet communications, or any other communications. It will be appreciated by those of ordinary skill in the art that although two communication devices and two base stations are illustrated in FIG. 2, any quantity of communication devices and base stations can be implemented in accordance with the present invention. In an embodiment, the communication device 225 and the communication device 235 is one of a cellular telephone, a portable personal communication device, or a desktop personal computer which is equipped to communicate over the wireless communication system. In another embodiment, the communication device 225 and the communication device 235 operate on multiple frequencies and use multiple communication protocols and communication standards. For example, each of the communication device 225 and 235 may be designed to operate over both a cellular air interface (e.g., Global System for Mobile communication (GSM), Code Division Multiple Access (CDMA), Wide-band CDMA (WCDMA), Universal Mobile Telecommunications System (UMTS), and the like) and an ad hoc networking air interface (e.g., BLUETOOTH, 802.11 WLAN (wireless local area network), 802.16 WiMax (Worldwide Interoperability for Microwave Access), and the like).

The base station 230 and the base station 240 communicate with a radio controller 245 over one of a wired connection and a wireless connection.

The dedicated communication channel 210 is characterized by one or more channel performance metrics 250. The one or more channel performance metrics 250 are obtained and stored by either the communication device 225 or the base station 230. The shared communication channel 220 is characterized by one or more channel performance metrics 255. The one or more channel performance metrics 255 are obtained and stored by either the communication device 235 or the base station 240. In an embodiment, the one or more channel performance metrics 250 and the one or more channel performance metrics 255 are obtained and stored by the radio controller 245. The one or more channel performance metrics 250 and 255, for example, can each include an interference level, a channel capacity, a channel quality, and/or a channel load.

In an embodiment, a centralized allocation approach is utilized for allocating all communications within the communication system 200. For example in the centralized allocation approach, the radio controller 245 operates to control the allocation of all communications within the communication system 200 including allocating the communication of the first plurality of communication traffic 205 between the communication device 225 and the base station 230 to the dedicated communication channel 210 and allocating the communication of the second plurality of communication traffic 215 between the communication device 235 and the base station 240 to the shared communication channel 220. In an alternative embodiment, a distributed allocation approach is utilized. In the distributed allocation approach, for example, the base station 230 allocates the communication of the first plurality of communication traffic 205 between itself and the communication device 225; and the base station 240 allocates the communication of the second plurality of communication traffic 215 between itself and the communication device 235.

Turning now to FIG. 3, a block diagram illustrating the subsequent introduction and detection of a degradation in one or more channel performance metrics of the shared communication channel in the communication system 200 of FIG. 2 in accordance with some embodiments. Specifically, FIG. 3 illustrates the introduction and detection of a degradation in the one or more channel performance metrics 255 of the shared communication channel 220 within the communication system 200. In an embodiment, the degradation in the one or more channel performance metrics 255 is a degradation in the one or more channel performance metrics 255 caused by a third plurality of communication traffic 305 between an interfering device 310 and an interfering device 315 over the at least one shared communication channel 220. Each of the interfering device 310 and the interfering device 315 can be, for example, a communication device, a base station, or any other electronic transmission device. The third plurality of communication traffic 305 may cause, for example, an increase in interference level, a decrease in channel capacity, a decrease in channel quality, or an increase in channel load of the at least one shared communication channel 220.

In an embodiment, one of the communication device 235, the base station 240 and the radio controller 245 detects the degradation in the one or more channel performance metrics 255 of the shared communication channel 220. The degradation may be detected due to an increase in interference level, a decrease in channel capacity, a decrease in channel quality, or an increase in channel load being beyond a predetermined threshold value.

Turning now to FIG. 4, a block diagram illustrating the re-allocation of at least some of the communication traffic from a shared communication channel to a dedicated communication channel in the communication system of FIGS. 2 and 3 in accordance with some embodiments. Specifically, the re-allocation of at least some of the second plurality of communication traffic 215 to the dedicated communication channel 210 is described hereafter. It will be appreciated that in some embodiments, the re-allocating causes the cardinality of the communication traffic on the dedicated communication channel 210 to increase.

In an embodiment, in response to the detecting a degradation in the one or more channel performance metrics 255, a bit rate used by at least some communication of one or more of the first plurality of communication traffic 205 and the second plurality of communication traffic 215 is decreased. The bit rate used by one or more of the first plurality of communication traffic 205 and the second plurality of communication traffic 215 may be decreased by configuring one or more of an audio encoding algorithm, a video encoding algorithm, a data compression algorithm, or a forward error correction algorithm, applied to at least some communication of one or more of the first plurality of communication traffic and the second plurality of communication traffic. This is explained in detail in conjunction with FIG. 6.

It will be appreciated by those of ordinary skill in the art, that although the example embodiment described in conjunction with FIGS. 3 and 4 corresponds to a degradation in one or more channel performance metrics of the shared communication channel in the communication system 200, alternatively (not illustrated) an improvement in one or more channel performance metrics of the shared communication channel in the communication system 200 can be responded to by re-allocating communication traffic from the dedicated communication channel to the shared communication channel in a similar manner.

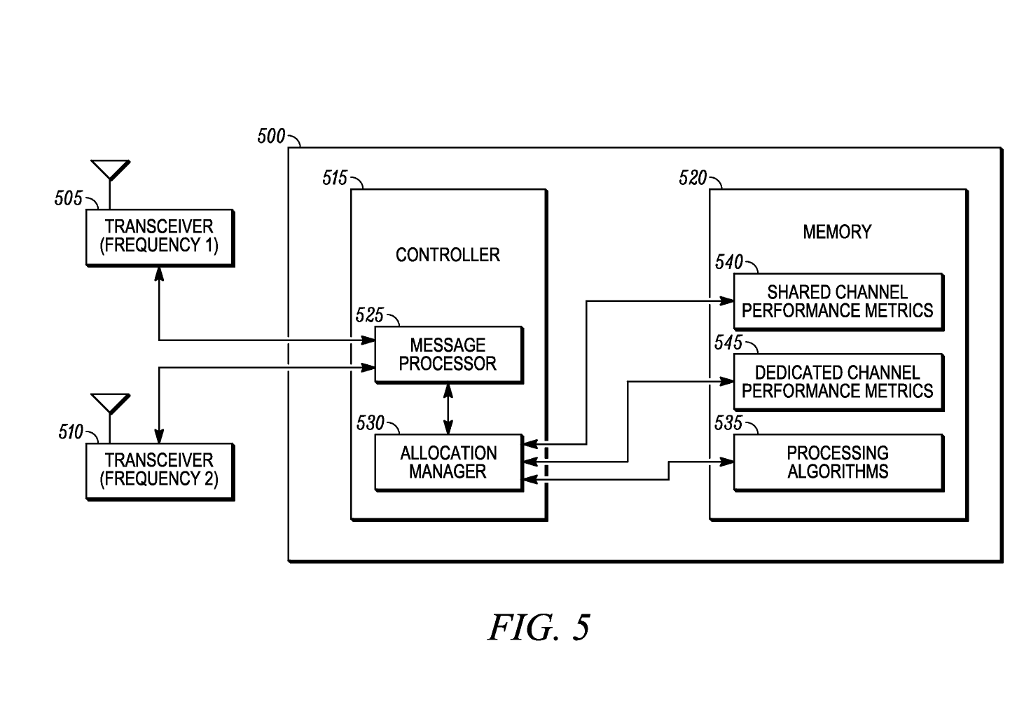

Turning now to FIG. 5, a block diagram illustrating a radio controller 500 operating within a communication system is described hereafter. In an embodiment, the radio controller 500 is the radio controller 245 of FIGS. 2, 3, and 4. The radio controller 500 includes a controller 515 and a memory 520. Further, the radio controller 500 controls a first transceiver 505, and a second transceiver 510. In an embodiment, the first transceiver 505 is the base station 240 of FIGS. 2, 3, and 4. In an embodiment, the second transceiver 510 may be the base station 230 of FIGS. 2, 3, and 4. The first transceiver 505 is configured to operate on a first frequency range or a first channel. In an embodiment, the first transceiver 505 is configured to operate on the shared communication channel 220. The second transceiver 510 is configured to operate on a second frequency range or a second channel. In an embodiment, the second transceiver 510 is configured to operate on the dedicated communication channel 210. The controller 515 includes a message processor 525 and an allocation manager 530. The message processor 525 processes signals received from the first transceiver 505 and the second transceiver 510. Further, the message processor 525 sends signals to the first transceiver 505 and the second transceiver 510. In an embodiment, at least one of the dedicated communication channels and the shared communication channels comprises a control channel and the message processor 525 sends one or more control messages over the control channel.

The allocation manager 530 manages allocating and re-allocating communication to various available channels. For example, the allocation manager 530 manages allocation of communication of a first plurality of communication traffic to at least one dedicated communication channel and communication of a second plurality of communication traffic to at least one shared communication channel. Further, when the allocation manager 530 detects a change in one or more channel performance metrics of the at the least one shared communication channel, it re-allocates communication traffic. For example, when the allocation manager 530 detects a degradation in one or more channel performance metrics of at least one shared communication channel, it re-allocates at least some communication of at least one of the second plurality of communication traffic to the at least one dedicated communication channel. Similarly, when the allocation manager 530 detects an improvement in one or more channel performance metrics of at least one shared communication channel, it re-allocates at least some communication of at least one of the first plurality of communication traffic to the at least one shared communication channel.

In an embodiment, the allocation manager 530 detects the change in one or more channel performance metrics of at least one shared communication channel using processing algorithms 535 stored in the memory 520. In an embodiment, one or more channel performance metrics include shared channel performance metrics 540 and dedicated channel performance metrics 545 stored in the memory 520. The shared channel performance metrics 540 may correspond to the one or more channel performance metrics 255; and the dedicated channel performance metrics 545 may correspond to the one or more channel performance metrics 250.

Turning now to FIG. 6, a flowchart of a method for optimizing the use of a shared communication channel and a dedicated communication channel in a radio communication system in accordance with some embodiments is illustrated and described herein. For example, the shared communication channel can comprise at least one of an unlicensed spectrum and a licensed spectrum which are temporarily available for communication. At 605, the first communication traffic is allocated to the dedicated communication channel and the second communication traffic is allocated to the shared communication channel. Thereafter, at 610, it is checked whether there is an improvement in a channel performance metric of the shared communication channel. When no improvement in at least one of the channel performance metrics of the shared communication channel is detected, the process goes to step 615, to check whether there is degradation in a channel performance metric of the shared communication channel. When, at 615, a degradation is detected in at least one of the channel performance metrics of the shared communication channel, the bit-rates used by traffic flows on the dedicated and shared communication channels are decreased at 620. In response to decreasing the bit-rates, at 625, at least some of the second communication traffic is re-allocated from the shared communication channel to the dedicated communication channel to form a third plurality of communication traffic over the dedicated communication channel. In an embodiment, the bit-rates of the third plurality of communication traffic are lower than bit-rates of the first communication traffic. In an embodiment, at least one of the dedicated communication channels and shared communication channels comprises a control channel; and one or more control signals are communicated over the control channel. Thereafter, at least some of the second plurality of communication traffic is re-allocated to at least one dedicated communication channel in response to information in the one or more control signals. When, at 615, a degradation in the channel performance metric of the shared communication channel is not detected, the process goes back to step 610.

Returning to 610, when an improvement in a channel performance metric of the shared communication channel is detected, at 630, at least some of the first communication traffic is re-allocated from the dedicated communication channel to the shared communication channel to form a fourth plurality of communication traffic over the shared communication channel. In another embodiment in which an improvement in the channel performance metrics of the shared channel is detected, at least some of the first plurality of communication traffic is re-allocated to the at least one shared communication channel in response to information in the one or more control signals. In response to re-allocation, at 635, bit-rates used by traffic flows on the dedicated and shared communication channels are increased. In an embodiment, bit-rates of the fourth plurality of communication traffic are lower than bit-rates of the second communication traffic. In an embodiment, the bit rates of calls moved to the shared communication channel may be lower than the bit rates of calls currently communicating on the shared communication channel.

In accordance with some embodiments, a method for optimizing the use of at least one shared radio communication channel and at least one dedicated radio communication channel in a radio communication system is described hereafter. The at least one shared radio communication channel comprises at least one of an unlicensed spectrum and a licensed spectrum which are temporarily available for communication of communication traffic. First, communication of a first plurality of communication traffic is allocated to the at least one dedicated radio communication channel and communication of a second plurality of communication traffic is allocated to the at least one shared radio communication channel. Thereafter, a change in the performance of the at least one shared radio communication channel is detected. The performance comprises one or more of an interference level, a channel capacity, a channel quality, or a channel load. Next, a bit rate used by at least some communication of one or more of the first plurality of communication traffic and the second plurality of communication traffic is changed in response to the detecting step by configuring one or more of an audio encoding algorithm, a video encoding algorithm, a data compression algorithm, or a forward error correction algorithm, applied to the at least some communication of one or more of the first plurality of communication traffic and the second plurality of communication traffic. Finally, one or more control messages are communicated over one or more of the at least one shared radio communication channel and the at least one dedicated radio communication channel to cause the re-allocation of at least some of the second plurality of communication traffic to the dedicated communication channel in response to the detecting step by communicating a message.

In accordance with some embodiments, a method for optimizing the use of at least one shared radio communication channel and at least one dedicated radio communication channel in a radio communication system is described hereafter. The at least one shared radio communication channel comprises at least one of an unlicensed spectrum and a licensed spectrum, which are temporarily available for communication of communication traffic. First, communication of a first plurality of communication traffic is allocated to the at least one dedicated radio communication channel and communication of a second plurality of communication traffic is allocated to the at least one shared radio communication channel. Thereafter, a change is detected in the performance of the at least one shared radio communication channel. The performance comprises one or more of an interference level, a channel capacity, a channel quality, or a channel load. Next, a bit rate used by at least some communication of one or more of the first plurality of communication traffic and the second plurality of communication traffic is changed in response to the detecting step by configuring one or more of an audio encoding algorithm, a video encoding algorithm, a data compression algorithm, or a forward error correction algorithm, applied to the at least some communication of one or more of the first plurality of communication traffic and the second plurality of communication traffic. Finally, one or more control messages are communicated over one or more of the at least one shared radio communication channel and the at least one dedicated radio communication channel to cause the re-allocation of at least some of the first plurality of communication traffic to the shared communication channel in response to the detecting step.

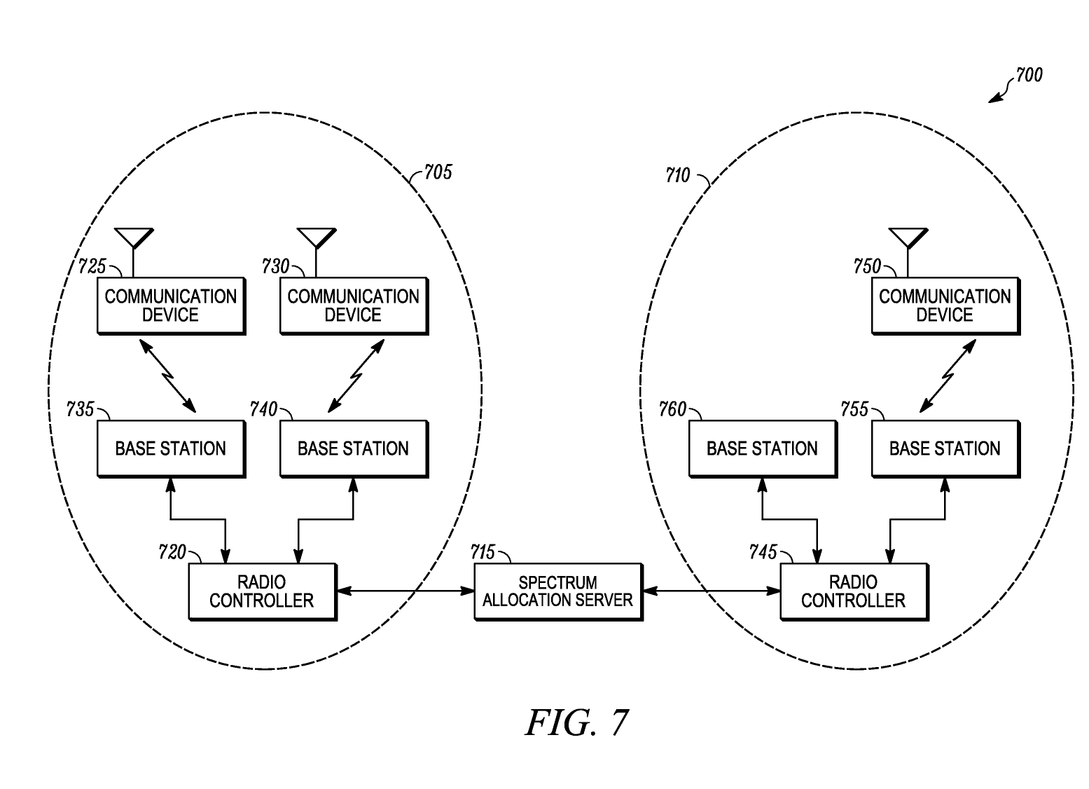

FIG. 7 is a block diagram of an example wireless communication network operating in accordance with some embodiments and indicated generally as 700. The wireless communication network 700 includes a first wireless network 705, a second wireless network 710 and a spectrum allocation server 715. It will be appreciated by those of ordinary skill in the art that although two wireless networks are illustrated in FIG. 7, any number of wireless networks can be implemented in accordance with the present invention. The first wireless network 705 includes a radio controller 720 for controlling communication with a communication device 725 and a communication device 730. The communication device 725 is operating on a first frequency range or a first channel. The communication device 730 is operating on a second frequency range or a second channel. The first channel corresponds to at least one dedicated channel for the first wireless network 705; whereas, the second channel corresponds to at least one shared channel for the first wireless network 705. The radio controller 720 communicates with the communication device 725 and the communication device 730 through a base station 735 and a base station 740. The radio controller 720, for example, can be the radio controller 500 of FIG. 5.

Similarly, the second wireless network 710 includes a radio controller 745 for controlling communication with a communication device 750. The communication device 750 is operating on a third frequency range or a third channel. The radio controller 745 communicates with the communication device 750 through a base station 755. The radio controller 745 uses a base station 760 for communicating with the communication devices operating on the second channel. The third channel corresponds to at least one dedicated channel for the second wireless network 710; whereas, the second channel corresponds to at least one shared channel for the second wireless network 710.

The spectrum allocation server 715 is communicatively coupled to the radio controller 720 and the radio controller 745. The spectrum allocation server 715 controls the use of licensed spectrum which it may allocate to the first wireless network 705 and the second wireless network 710. The spectrum allocation server 715 allocates spectrum on either a short-term basis or a long-term basis. In an embodiment, the at least one shared communication channel includes at least one of an unlicensed spectrum and a licensed spectrum which are temporarily available for communication of communication traffic. The licensed spectrum is temporarily made available for communication of communication traffic as a result of a decision using at least one of an automated negotiation protocol, an automated auction mechanism, and an automated application of policy rules implemented by the spectrum allocation server 715.

In an embodiment, the spectrum allocation server 715 facilitates negotiation for available spectrum among various wireless networks, which may include the first wireless network 705 and the second wireless network 710. The available spectrum may include at least one communication channel originally licensed to a wireless network on a long-term basis by a responsible government entity such as the Federal Communications Commission (FCC). The wireless network to which a channel was originally licensed may not require use of that channel for a certain duration of time and may temporarily lease use of that channel to other wireless networks via a secondary market conducted automatically by the spectrum allocation server 715. Therefore, the amount of the available spectrum can vary from time to time. In another embodiment, the spectrum allocation server 715 auctions available spectrum to various wireless networks, which may include the first wireless network 705 and the second wireless network 710. The format of the auctions may be at least one of a Dutch auction format, an English auction format, or any other auction format. The spectrum allocation server 715 informs the wireless networks regarding the start of an auction. In another embodiment, a wireless network may place a request with the spectrum allocation server 715 to start an auction of the available spectrum. The wireless networks may place bids based on their bandwidth requirements. The status information regarding the auction and other such parameters are made available by the spectrum allocation server 715. The spectrum allocation server 715 allocates or leases the available spectrum or a part of the available spectrum, for a specific duration, to a wireless network with a winning bid. In yet another embodiment, the spectrum allocation server 715 may implement policy rules to lease or allocate the available spectrum among various wireless networks, which may include the first wireless network 705 and the second wireless network 710. Policy rules may include a first come first served policy rule, a strict priority policy rule allowing preemption of allocations, or various other policy rules.

In an embodiment, the spectrum allocation server 715 leases spectrum on a long term basis to various wireless networks, which may include the first wireless network 705 and the second wireless network 710.

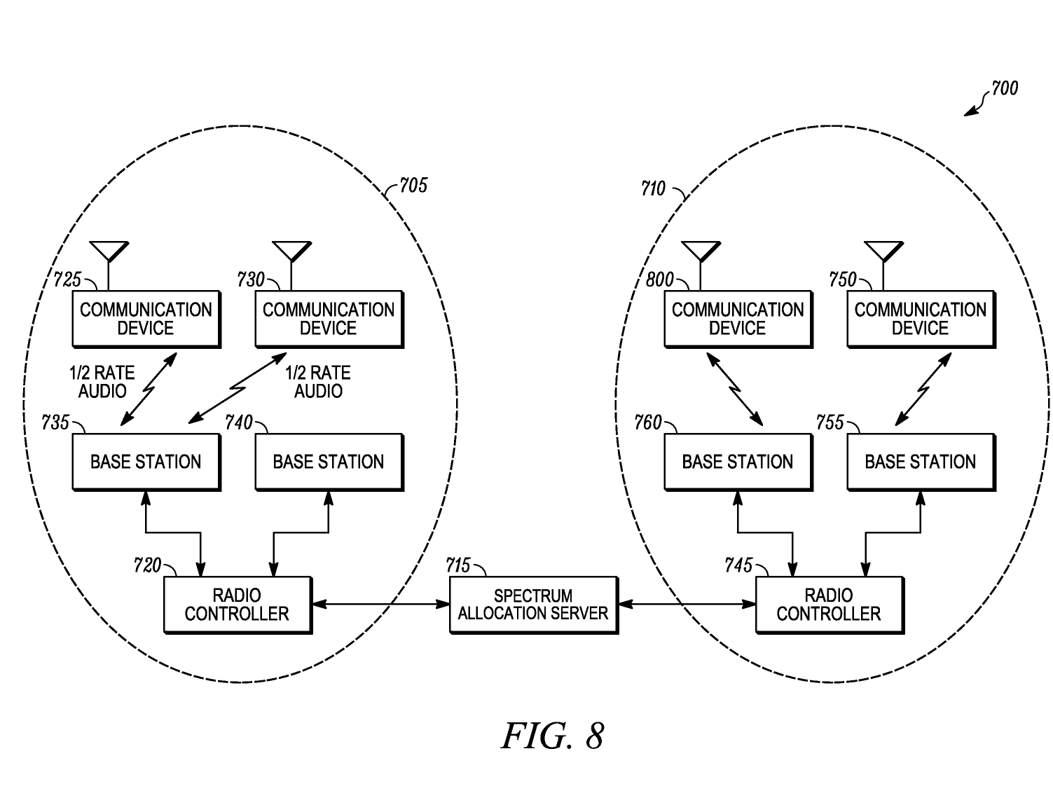

Turning now to FIG. 8, a block diagram illustrating an example wireless communication network 700 operating in accordance with some embodiments is described hereafter. At a point in time the second wireless network 710 has a need for use of an additional communication channel to carry the traffic of communication device 800. In order to obtain use of an additional channel, the radio controller 745 sends a message to the spectrum allocation server 715 indicating its willingness to pay a price for use of an additional channel. Based on information in its internal database, the spectrum allocation server 715 determines that the first wireless network 705 has previously registered its willingness to lease the second channel for a period of time at that price. The spectrum allocation server 715 sends a message to the radio controller 720 of the first wireless network 705 indicating that it should cease use of the second channel. The radio controller 720 sends messages to the communication device 725 via the base station 735 and to the communication device 730 via the base station 740 directing them to reduce the bit rates used by their audio communication to ½ of what they had previously been using. The radio controller 720 also sends a message to the communication device 730 via the base station 740 directing it to discontinue communicating with the base station 740 using the second channel and to commence communication with the base station 735 using the first channel. The communication devices 725 and 730 perform the changes based on the directions received, after which the radio controller 720 sends a message to the spectrum allocation server 715 indicating that the second channel has been vacated. In response, the spectrum allocation server 715 sends a message to the radio controller 745 indicating that the second channel is now allocated to the second wireless network 710 for a time period. The radio controller 745 then sends a message to the base station 760 directing it to carry the communication traffic of the communication device 800 using the second channel.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for optimizing the use of at least one shared communication channel and at least one dedicated communication channel in a communication system, the method comprising:
allocating communication of a first plurality of communication traffic to the at least one dedicated communication channel and communication of a second plurality of communication traffic to the at least one shared communication channel;
detecting a change in one or more channel performance metrics of the at least one shared communication channel;
re-allocating at least some communication of at least one of the second plurality of communication traffic to the at least one dedicated communication channel when the detected change is a degradation in the one or more channel performance metrics of the at least one shared communication channel; and
re-allocating at least some communication of at least one of the first plurality of communication traffic to the at least one shared communication channel when the detected change is an improvement in one or more channel performance metrics of the at least one shared communication channel.

2. The method of claim 1, wherein the one or more channel performance metrics comprise an interference level, a channel capacity, a channel quality, or a channel load.

3. The method of claim 2, wherein the channel load is determined using one or more of a number of communication users, a bandwidth requirement of the communication users, and an amount of available spectrum.

4. The method of claim 1, wherein at least one of the dedicated communication channels and the shared communication channels comprises a control channel, the method further comprising:
communicating one or more control messages over the control channel.

5. The method of claim 4, further comprising:
re-allocating at least some of the second plurality of communication traffic to the at least one dedicated communication channel in response to information within the one or more control messages.

6. The method of claim 4, further comprising:
re-allocating at least some of the first plurality of communication traffic to the at least one shared communication channel in response to information within the one or more control messages.

7. The method of claim 1, wherein the communication system comprises one of a radio communication system, a wired communication system, and a fiber optic communication system.

8. The method of claim 1, wherein the communication system comprises a radio communication system, and further wherein the at least one shared communication channel comprises at least one of an unlicensed spectrum and a licensed spectrum which are temporarily available for communication of communication traffic.

9. The method of claim 8, wherein the licensed spectrum is temporarily made available for communication of communication traffic as a result of a decision using at least one of an automated negotiation protocol, an automated auction mechanism, and an automated application of policy rules.

10. The method of claim 1, wherein the re-allocating steps cause a cardinality of the communication traffic on the at least one dedicated communication channel and the at least one shared communication channel to change.

11. The method of claim 1, further comprising:
changing a bit rate used by at least some communication of at least one of the first plurality of communication traffic and the second plurality of communication traffic in response to the detecting step.

12. The method of claim 11, wherein changing a bit rate used by at least one communication of at least one of the first plurality of communication traffic and the second plurality of communication traffic comprises configuring one or more of an audio encoding algorithm, a video encoding algorithm, a data compression algorithm, or a forward error correction algorithm, applied to the at least some communication of at least one of the first plurality of communication traffic and the second plurality of communication traffic.

13. The method of claim 1, further comprising after the detecting step:
communicating a third plurality of communication traffic over the at least one dedicated communication channel, wherein a bit rate of the third plurality of communication traffic is lower than a bit rate of the first plurality of communication traffic.

14. The method of claim 1, further comprising after the detecting step:
communicating a fourth plurality of communication traffic over the at least one shared communication channel, wherein a bit rate of the fourth plurality of communication traffic is lower than a bit rate of the second plurality of communication traffic.

15. A method for optimizing the use of at least one shared radio communication channel and at least one dedicated radio communication channel in a radio communication system in which the shared radio communication channel comprises at least one of an unlicensed spectrum and a licensed spectrum which are temporarily available for communication of communication traffic, the method comprising:
allocating communication of a first plurality of communication traffic to the at least one dedicated radio communication channel and communication of a second plurality of communication traffic to the at least one shared radio communication channel;
detecting a change in the performance of the at least one shared radio communication channel, wherein the performance comprises one or more of an interference level, a channel capacity, a channel quality, or a channel load;
changing a bit rate used by at least some communication of at least one of the first plurality of communication traffic and the second plurality of communication traffic in response to the detecting step by configuring one or more of an audio encoding algorithm, a video encoding algorithm, a data compression algorithm, or a forward error correction algorithm, applied to the at least some communication of at least one of the first plurality of communication traffic and the second plurality of communication traffic; and
communicating one or more control messages over one or more of the at least one shared radio communication channel and the at least one dedicated radio communication channel to cause the re-allocation of at least some of the second plurality of communication traffic to the dedicated communication channel in response to the detecting step by communicating a message.

16. A method for optimizing the use of at least one shared radio communication channel and at least one dedicated radio communication channel in a radio communication system in which the shared radio communication channel comprises at least one of an unlicensed spectrum and a licensed spectrum which are temporarily available for communication of communication traffic, the method comprising:
allocating communication of a first plurality of communication traffic to the at least one dedicated radio communication channel and communication of a second plurality of communication traffic to the at least one shared radio communication channel;
detecting a change in the performance of the at least one shared radio communication channel, wherein the performance comprises one or more of an interference level, a channel capacity, a channel quality, or a channel load;
changing a bit rate used by at least some communication of at least one of the first plurality of communication traffic and the second plurality of communication traffic in response to the detecting step by configuring one or more of an audio encoding algorithm, a video encoding algorithm, a data compression algorithm, or a forward error correction algorithm, applied to the at least some communication of at least one of the first plurality of communication traffic and the second plurality of communication traffic; and
communicating one or more control messages over one or more of the at least one shared radio communication channel and the at least one dedicated radio communication channel to cause the re-allocation of at least some of the first plurality of communication traffic to the shared communication channel in response to the detecting step.

17. A method for optimizing the use of at least one shared communication channel and at least one dedicated communication channel in a communication system, the method comprising:
allocating communication of a first plurality of communication traffic to the at least one dedicated communication channel and communication of a second plurality of communication traffic to the at least one shared communication channel;
detecting a change in one or more channel performance metrics of the at least one shared communication channel; and
re-allocating at least some communication of at least one of the second plurality of communication traffic to the at least one dedicated communication channel when the detected change is a degradation greater than a change threshold value in the one or more channel performance metrics of the at least one shared communication channel.
